(19) United States
(12) Patent Application Publication
(10) Pub. No.: US 2021/0226518 A1
(43) Pub. Date: Jul. 22, 2021

(54) METHOD FOR REMOVING MATERIAL OF ROTOR ASSEMBLY TO REACH DYNAMIC BALANCE SITUATION

(71) Applicant: TECO Electric & Machinery Co., Ltd., Taipei City (TW)

(72) Inventors: Lian-Shin HUNG, Taipei City (TW); Ming-Te HO, Taipei City (TW); Po-Jen CHIU, Taipei City (TW); Rung-Sheng TSAI, Taipei City (TW)

(21) Appl. No.: 16/837,492

(22) Filed: Apr. 1, 2020

(30) Foreign Application Priority Data
Jan. 20, 2020 (TW) 109102021

(51) Int. Cl. H02K 15/16

(52) U.S. Cl. CPC H02K 15/165

(57) ABSTRACT

A method applied for removing a material of a rotor assembly to reach a dynamic balance situation includes the steps of: (1) applying a dynamic-balance investigating means to calculate a mass removal angle and a removal mass corresponding to the mass removal angle for a mass-removing process that is performed at one of two rotor constraint plates in order to have the rotor assembly to reach the dynamic balance situation; (b) determining a mass removal position on the peripheral surface according to the mass removal angle, and calculating a corresponding drilling depth at the mass removal position according to the removal mass; and (c) applying a mass-removing tool to make a mass removal hole having the drilling depth at the mass removal position.

This application claims the benefit of Taiwan Patent Application Serial No. 109102021, filed Jan. 20, 2020, the subject matter of which is incorporated herein by reference.

### BACKGROUND OF THE INVENTION

### (1) Field of the Invention

The invention relates to a method, and more particularly to a method for removing a material of a rotor assembly so as to have the rotor assembly to reach a dynamic balance situation.

### (2) Description of the Prior Art

A motor, or say an electric motor, is an electric device to transform an electric energy into a corresponding kinetic energy for energizing or driving other apparatuses and electric devices. The motor has been widely applied in modern life.

Generally, a typical motor includes a rotor assembly, a stator assembly and a motor frame. In order to reduce vibrations and noises caused from operating the motor, a dynamic-balance investigating means can be introduced to investigate the motor, and thereby a mass-adding process or a mass-removing process can be performed on the rotor assembly so as to have the rotor assembly to achieve a dynamic balance situation.

Referring to FIG. 1, a typical mass-removing process on the rotor assembly is schematically shown. In FIG. 1, a rotor assembly PA1 includes a rotor axle PA11 a rotor body PA12 and two rotor constraint plates PA13 (one shown in the figure). The rotor axle PA11 extends in an axial direction PAX to penetrate through the rotor body PA12 and the two rotor constraint plates PA13. The rotor constraint plate PA13, furnished to one end of the rotor body PA12, has an end plane PAS1 and a peripheral surface PAS2. In addition, the constraint plate PA13 has a constraint-plate thickness PAT.

In the art, the mass-removing process is performed on the end plane PAS1. In each of the mass-removing process, a mass removal hole PAH is formed by drilling, for example. Generally, a series of the mass-removing processes shall be performed repeatedly before the rotor assembly PA1 reach the expected dynamic balance situation. Hence, it is possible that a plurality of mass removal holes PAH would be formed simultaneously on the rotor constraint plate PA13 (four shown in the figure) prior to reach the dynamic balance situation. In this practice, the removal mass is proportional to the drilling depth PAD of the mass removal hole PAH, and the drilling depth PAD is limited by the constraint-plate thickness PAT.

Obviously, conventionally, before the rotor assembly PAI can reach the dynamic balance situation by removing masses, multiple mass-removing processes might be performed by drilling a plurality of mass removal holes PAH. However, the additional mass-removing processes may complicate the entire manufacturing process, and also reduce the yield of manufacturing. Thus, the conventional mass-removing process as described above needs to be improved definitely.

### SUMMARY OF THE INVENTION

In view that, in the art, the constraint-plate thickness of the rotor constraint plate would limit the drilling depth of the mass removal hole, thus various further problems may be caused from the aforementioned mass-removing process. Accordingly, it is an object of the present invention to provide a method for removing a material of a rotor assembly to reach a dynamic balance situation, by which at least one of the aforesaid shortcomings described above can be resolved.

In the present invention, the method for removing a material of a rotor assembly to reach a dynamic balance situation is applied at the timing when the rotor assembly is yet to reach a dynamic balance situation. The rotor assembly includes a rotor body extending in an axial direction and two opposing rotor constraint plates disposed at opposing ends of the rotor body. Each of the two rotor constraint plates has a peripheral surface. The method of the present invention includes: a step (a) of applying a dynamic-balance investigating means to calculate a mass removal angle and a removal mass corresponding to the mass removal angle for a mass-removing process that is performed at one of the two rotor constraint plates in order to have the rotor assembly to reach the dynamic balance situation; a step (b) of determining a mass removal position on the peripheral surface according to the mass removal angle, and calculating a corresponding drilling depth at the mass removal position according to the removal mass; and, a step (c) of applying a mass-removing tool to make a mass removal hole having the drilling depth at the mass removal position.

In one embodiment of the present invention, the step (c) further includes a step (c1) of applying the mass-removing tool to drill the mass removal hole in a radial direction perpendicular to the axial direction.

In one embodiment of the present invention, the rotor constraint plate has a constraint-plate radius, and the drilling depth is less than the constraint-plate radius.

In one embodiment of the present invention, the method for removing a material of a rotor assembly to reach a dynamic balance situation further includes a step (d) of applying the dynamic-balance investigating means to determine whether or not the rotor assembly has reached the dynamic balance situation, and then repeating the step (a) if the rotor assembly still has not reached the dynamic balance situation.

In one embodiment of the present invention, the mass-removing tool is one of an electric driller and a drilling device.

As stated, in comparison with the conventional art that the mass removal holes are furnished to the end surface of the rotor constraint plate, the present invention produces the mass removal holes on the peripheral surface of the rotor constraint plate. Thereupon, the drilling depth can be made larger so as able to reduce the required number of the mass removal holes, if the removal mass is the same. Thus, the number of the required mass-removing processes can be reduced as well, and so the production can be substantially raised.

All these objects are achieved by the method for removing a material of a rotor assembly to reach a dynamic balance situation described below.

### BRIEF DESCRIPTION OF THE DRAWINGS

The present invention will now be specified with reference to its preferred embodiment illustrated in the drawings, in which:

FIG. 1 demonstrates schematically a typical mass-removing process performed on a conventional rotor assembly;

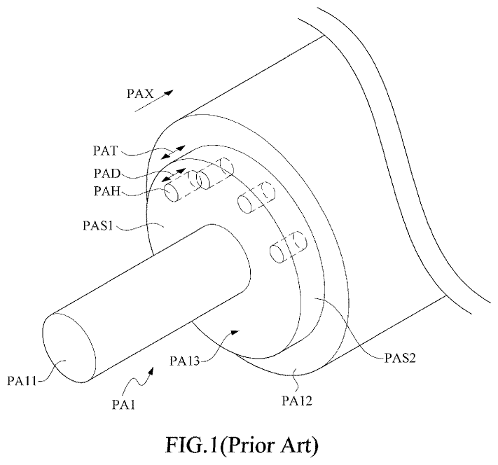

FIG. 2 is a flowchart of the preferred method for removing a material of a rotor assembly to reach a dynamic balance situation in accordance with the present invention;

FIG. 3 is a schematic perspective view of a motor rotor assembly;

FIG. 4 demonstrates a mass removal hole furnished to a peripheral surface of the motor rotor assembly in accordance with the present invention;

FIG. 5 is a schematic cross-sectional view of FIG. 4 along line A-A; and

FIG. 6 is a schematic cross-sectional view of FIG. 4 along line B-B.

### DESCRIPTION OF THE PREFERRED EMBODIMENT

The invention disclosed herein is directed to a method for removing a material of a rotor assembly to reach a dynamic balance situation. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

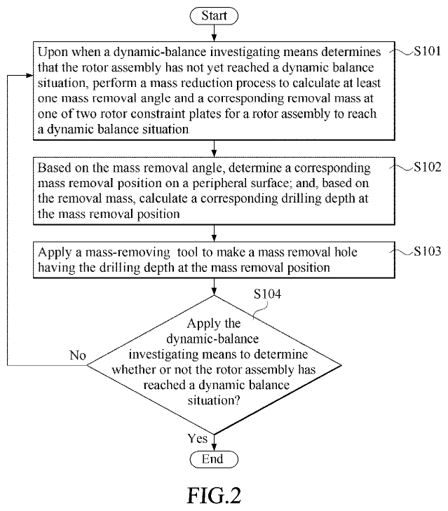

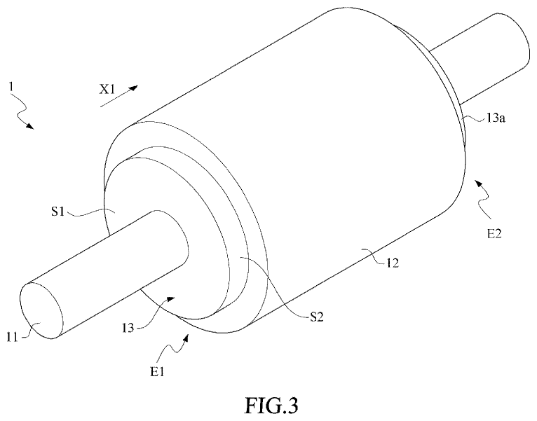

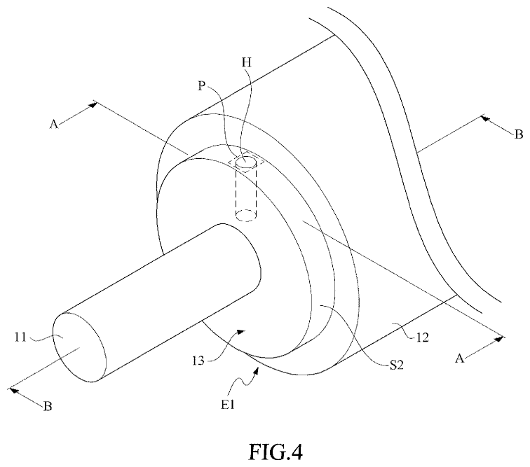

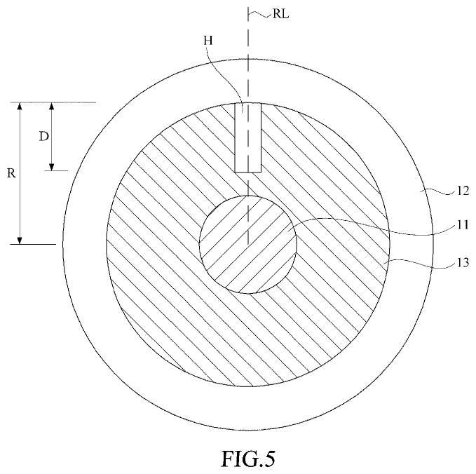

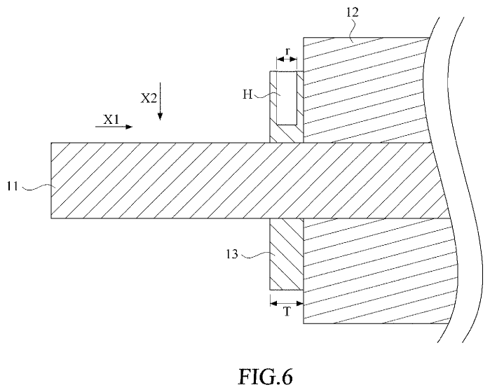

Refer to FIG. 2 through FIG. 6; where FIG. 2 is a flowchart of the preferred method for removing a material of a rotor assembly to reach a dynamic balance situation in accordance with the present invention, FIG. 3 is a schematic perspective view of a motor rotor assembly, FIG. 4 demonstrates a mass removal hole furnished to a peripheral surface of the motor rotor assembly in accordance with the present invention, FIG. 5 is a schematic cross-sectional view of FIG. 4 along line A-A, and FIG. 6 is a schematic cross-sectional view of FIG. 4 along line B-B. As shown, in this present invention, the method for removing a material of a motor rotor assembly 1 to reach a dynamic balance situation is performed at the timing that the motor rotor assembly 1 has yet to reach a dynamic balance situation. The method includes Step S101 to Step S104 as follows. The motor rotor assembly 1 includes a rotor axle 11 extending in an axial direction X1, a rotor body 12 extending also in the axial direction X1, and two rotor constraint plates 13, 13a. The two opposing rotor constraint plates 13, 13a are assembled to a first end portion E1 and a second end portion E2, respectively, on the rotor body 12. Each of the rotor constraint plates 13, 13 a has an end plane S1 and a peripheral surface S2.

Step S101: Introduce a dynamic-balance investigating means to calculate a mass removal angle and a removal mass corresponding to the mass removal angle for a mass-removing process that will be performed at one of the two rotor constraint plates in order to have the motor rotor assembly to reach a dynamic balance situation.

In the art, the dynamic-balance investigating means is well known to the skill, and thus details thereabout would be omitted herein. The dynamic-balance investigating means would determine a mass removal angle and a corresponding removal mass for one of the two rotor constraint plates 13, 13a. In this embodiment, the rotor constraint plate 13 is taken as, but not limited to be, an example. (Obviously, the rotor constraint plate 13a can be another example.) The mass removal angle is an angle with respect to a reference line RL. In this embodiment, the mass removal angle is set to be 0°. As shown in FIG. 5, the mass removal angle can be, but not limited to, 30°, 60°, 150° or any other angle other than 0°.

Step S102: According to the mass removal angle, a mass removal position on the peripheral surface can be determined. Then, based on the removal mass, a corresponding drilling depth at the mass removal position can be calculated.

Generally speaking, the dynamic-balance investigating means would make a mark and the removal mass on the end surface 51 of the rotor constraint plate 13, such that the mass-removing process can be correctly performed at the right position marked on the end plane 51. In this invention, according to the aforesaid dynamic-balance investigating means, the mark would guide to drill a hole on the peripheral surface at the mass removal position P, by the corresponding mass removal angle, and with the drilling depth D calculated by the dynamic-balance investigating means, such that the expected removal mass can be removed from the mass removal position.

In comparison with the prior technique, the drilling depth D provided by this invention may be be larger than the aforesaid drilling depth PAD. Thus, it implies that, under the same demand in removal mass, a quantity of the mass removal holes H according to the present invention would be less than that needed in the conventional mass removal holes PAH. Namely, a less number of the mass-removing processes are required for the mass-reduction process in accordance with this invention, and thus the entire production can be further enhanced.

Step S103: Apply a mass-removing tool to make a mass removal hole having the drilling depth at the mass removal position.

In this embodiment, the mass-removing tool can be an electric driller, a drilling device or any device that can be used for performing the mass-removing process on the peripheral surface S2 of the motor rotor assembly 1. The mass-removing tool is applied to drill a mass removal hole H on the peripheral surface S2 by the drilling depth PAD.

Preferably, as shown in FIG. 6, the mass-removing tool would drills the mass removal hole H in a radial direction X perpendicular to the axial direction X1. Therefore, an obvious advantage from such a manner for producing the mass removal hole H extending in the radial direction X2 is that, if a plurality of the mass removal holes H is needed, any possible interference between every two neighboring mass removal holes H would be reduced to a minimum. Also, the number and positions of the mass removal holes H can be versatile arranged to meet the required removal mass. In another embodiment, the mass-removing tool can be performed to drill a mass removal hole H oblique to the axial direction X1. However, such a manner to provide the mass removal holes H would increase the burden in investigations for reaching the dynamic balance situation, and complicate the calculations in determining the mass removal angles and the corresponding removal masses in the following mass-removing processes. Also, more limitations in forming the required mass removal holes H can be expected.

As shown in FIG. 5, though the drilling depth D is limited by a constraint-plate radius R of the rotor constraint plate 13, yet the resulted drilling depth D of this invention can be still larger than the conventional drilling depth PAD, which is obviously limited by the constraint-plate thickness PAT. Thus, the total or individual allowable removal masses from the mass removal holes H provided by this invention would be larger than that provided by the conventional mass removal holes PAH. Similarly, with the same removal mass to be removed, the required number of the mass removal holes H would be less than that in the conventional technique. For example, if the drilling depth D is four times the drilling depth PAD, then the required number of the mass removal holes H in this invention would be ¼ of the required number of the aforesaid mass removal holes PAH. In other words, the number in performing the mass-removing process in accordance with the present invention would be only 1/4 of that in the prior art, such that the yield in producing the mass-reduced rotor assembly would be raised by four times.

It shall be explained that the practical constraint-plate radius R of the rotor constraint plate 13 can be freely enlarged to be almost equal to the radius of the rotor body 12. Namely, the dimensions provided by the drawings herein do not follow real configurations, but are only used for meeting the purpose of concisely distinguishing the rotor constraint plate 13 from the rotor body 12.

As shown in FIG. 6, though the hole diameter r of the mass removal hole H is limited by the thickness T of the rotor constraint plate 13, yet practically the constraint-plate thickness T would meet the minimal dimension of the mass-removing tool (about 3 mm) In addition, the mass-removing tool adopted in this present invention can be the same as that in the art, and thus the limitation upon the hole diameter r of the mass removal hole H would be no difference between the present invention and the conventional technique.

Thus, without any major change in the dynamic-balance investigating means and the mass-removing tool, the present invention can simplify the hole forming process and enhance the yield by simply altering the position of the mass removal hole having the drilling depth D to the peripheral surface S2.

Step S104: Apply the dynamic-balance investigating means to determine whether or not the rotor assembly has reached a dynamic balance situation.

After all the required mass removal holes H are provided, the dynamic-balance investigating means is introduced again to investigate whether or not the dynamic balance situation of the motor rotor assembly 1 has been reached. If positive, then the method is ended. Otherwise, go back to repeat Step S101; i.e., to initiate another run from Step S101 to S104, till the motor rotor assembly 1 is determined to meet the dynamic balance situation.

In summary, in comparison with the conventional art that the mass removal holes are furnished to the end surface of the rotor constraint plate, the present invention produces the mass removal holes on the peripheral surface of the rotor constraint plate. Thereupon, the drilling depth can be made larger so as able to reduce the required number of the mass removal holes, if the removal mass is the same. Thus, the number of the required mass-removing processes can be reduced as well, and so the production can be substantially raised.

While the present invention has been particularly shown and described with reference to a preferred embodiment, it will be understood by those skilled in the art that various changes in form and detail may be without departing from the spirit and scope of the present invention.

What is claimed is:

1. A method for removing a material of a rotor assembly to reach a dynamic balance situation, the rotor assembly including a rotor body extending in an axial direction and two opposing rotor constraint plates disposed at opposing ends of the rotor body, each of the two rotor constraint plates having a peripheral surface, the method being applied upon when the rotor assembly is yet to reach a dynamic balance situation and comprising the steps of:
(a) applying a dynamic-balance investigating means to calculate a mass removal angle and a removal mass corresponding to the mass removal angle for a mass-removing process that is performed at one of the two rotor constraint plates in order to have the rotor assembly to reach the dynamic balance situation;
(b) determining a mass removal position on the peripheral surface according to the mass removal angle, and calculating a corresponding drilling depth at the mass removal position according to the removal mass; and
(c) applying a mass-removing tool to make a mass removal hole having the drilling depth at the mass removal position.

2. The method for removing a material of a rotor assembly to reach a dynamic balance situation of claim 1, wherein the step (c) further includes a step (c1) of applying the mass-removing tool to drill the mass removal hole in a radial direction perpendicular to the axial direction.

3. The method for removing a material of a rotor assembly to reach a dynamic balance situation of claim 2, wherein the rotor constraint plate has a constraint-plate radius, and the drilling depth is less than the constraint-plate radius.

4. The method for removing a material of a rotor assembly to reach a dynamic balance situation of claim 1, further including a step (d) of applying the dynamic-balance investigating means to determine whether or not the rotor assembly has reached the dynamic balance situation, and then repeating the step (a) if the rotor assembly still has not reached the dynamic balance situation.

5. The method for removing a material of a rotor assembly to reach a dynamic balance situation of claim 1, wherein the mass-removing tool is one of an electric driller and a drilling device.
